(19) United States
(12) Patent Application Publication
(10) Pub. No.: US 2012/0075315 A1
(43) Pub. Date: Mar. 29, 2012

(54) METHOD FOR PERFORMING VIDEO PROCESSING BASED UPON A PLURALITY OF COMMANDS, AND ASSOCIATED VIDEO PROCESSING CIRCUIT

(76) Inventors: Guoping Li, Anhui Province (CN); Shih-Rong Kao, Hsinchu City (TW)

(21) Appl. No.: 13/130,299

(22) PCT Filed: Sep. 26, 2010
(86) PCT No.: PCT/CN10/77323

§ 371 Date: May 19, 2011

(51) Int. Cl. G06T 1/00

(52) U.S. Cl. 345/522

(57) ABSTRACT

A method for performing video processing based upon a plurality of commands is provided, where the method is applied to a video processing circuit. The method includes: grouping the commands into command chains, wherein the command chains have respective dependence relationships; and utilizing a plurality of hardware modules of the video processing circuit to execute the command chains, respectively. For example, at a time when the commands are grouped into the command chains, each command of one of the command chains is independent of any command of another of the command chains. In particular, the command chains include a first command chain and a second command chain, where the commands of the first command chain have a first dependence relationship, and the commands of the second command chain have a second dependence relationship. An associated video processing circuit is also provided.

### FIELD OF INVENTION

The present invention relates to video processing using multiple hardware modules, and more particularly, to a method for performing video processing based upon a plurality of commands, and to an associated video processing circuit.

### BACKGROUND OF THE INVENTION

Within a conventional system implemented according to the related art, a conventional graphics processing hardware module such as a graphics processing unit (GPU) is typically utilized for offloading three-dimensional (3-D) or two-dimensional (2-D) graphics rendering from a microprocessor of the conventional system. In particular, the conventional system can be an embedded system, a personal computer (PC), or a workstation. For example, in a situation where the conventional system is a PC, the conventional graphics processing hardware module such as the GPU may exist on the motherboard of the PC.

Typically, when it is required for the conventional system to utilize the conventional graphics processing hardware module, the microprocessor of the conventional system may directly send a command to the conventional graphics processing hardware module, and the conventional graphics processing hardware module executes the command as assigned by the microprocessor of the conventional system. However, considering the possibility of implementing a new architecture within a system in the future, such a straightforward scheme may not guarantee the system against inefficiency. Thus, a novel method is required for properly controlling a system equipped with the new architecture.

### SUMMARY OF THE INVENTION

It is therefore an objective of the claimed invention to provide a method for performing video processing based upon a plurality of commands, and to provide an associated video processing circuit, in order to achieve the best performance.

An exemplary embodiment of a method for performing video processing based upon a plurality of commands is provided, where the method is applied to a video processing circuit. The method comprises: grouping the commands into command chains, wherein the command chains have respective dependence relationships; and utilizing a plurality of hardware modules of the video processing circuit to execute the command chains, respectively. For example, at a time when the commands are grouped into the command chains, each command of one of the command chains is independent of any command of another of the command chains. In particular, the command chains comprise a first command chain and a second command chain, where the commands of the first command chain have a first dependence relationship, and the commands of the second command chain have a second dependence relationship.

An exemplary embodiment of an associated video processing circuit comprises a plurality of hardware modules and a controller. The hardware modules are arranged to perform video processing based upon a plurality of commands. In addition, the controller is arranged to group the commands into command chains, wherein the command chains have respective dependence relationships. Additionally, the controller utilizes the hardware modules to execute the command chains, respectively. For example, at a time when the commands are grouped into the command chains, each command of one of the command chains is independent of any command of another of the command chains. In particular, the command chains comprise a first command chain and a second command chain, where the commands of the first command chain have a first dependence relationship, and the commands of the second command chain have a second dependence relationship.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a video processing circuit according to a first embodiment of the present invention.

FIG. 2 is a flowchart of a method for performing video processing based upon a plurality of commands according to one embodiment of the present invention.

FIGS. 3A-3D illustrate some video processing operations involved with the method shown in FIG. 2 according to different embodiments of the present invention.

FIG. 4 illustrates some implementation details of the method shown in FIG. 2 according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

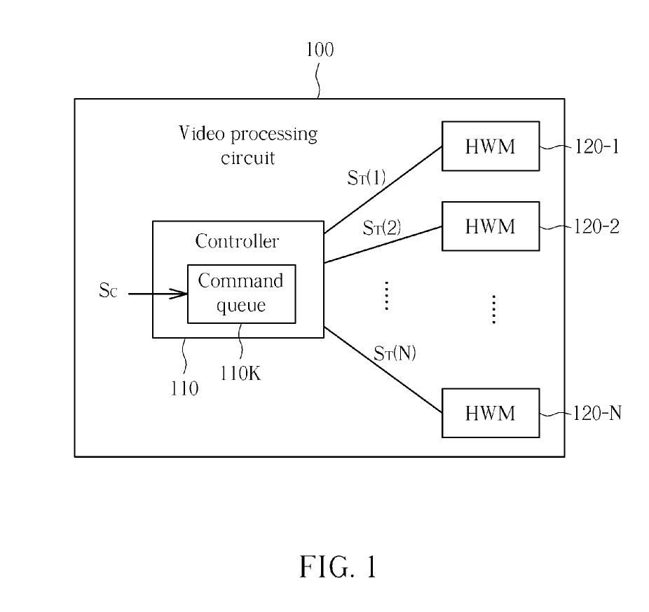

Please refer to FIG. 1, which illustrates a diagram of a video processing circuit 100 according to a first embodiment of the present invention. As shown in FIG. 1, the video processing circuit 100 comprises a controller 110 and a plurality of hardware modules 120-1, 120-2, . . . , and 120-N (respectively labeled “HWM” in FIG. 1), where the notation N represents a natural number. According to this embodiment, the controller 110 may receive a plurality of commands S_{C}, and a command queue 110K of the controller 110 is arranged to temporarily store the commands S_{C} and/or representatives thereof. For example, the video processing circuit 100 can be implemented within a system such as an embedded system, a personal computer (PC), or a workstation, and the system may comprise a microprocessor (not shown). Each hardware module of at least a portion of the hardware modules 120-1, 120-2, . . . , and 120-N (e.g. a portion or all of the hardware modules 120-1, 120-2, . . . , and 120-N) can be a graphics processing hardware module such as a graphics processing unit (GPU), where the GPU is typically utilized for offloading three-dimensional (3-D) or two-dimensional (2-D) graphics rendering from the microprocessor of the system. In particular, the controller 110 can be implemented as an individual component other than the microprocessor mentioned above. This is for illustrative purposes only, and is not meant to be a limitation of the present invention. According to a variation of this embodiment, the microprocessor mentioned above can be integrated into the controller 110, where the commands S_{C} of this variation can be generated by the controller 110 itself, rather than being received from outside the controller 110.

According to this embodiment, the hardware modules 120-1, 120-2, . . . , and 120-N are arranged to perform video processing based upon the commands S_{C}. More specifically, the controller 110 is arranged to group the commands S_{C} into command chains S_{CC}, where the command chains S_{CC} have respective dependence relationships. In addition, the controller 110 can utilize the hardware modules 120-1, 120-2, . . . , and 120-N to execute the command chains S_{CC}, respectively. For example, the command chains S_{CC} may comprise a first command chain S_{CC}(1) and a second command chain S_{CC}(2), where the commands of the first command chain S_{CC}(1) have a first dependence relationship, and the commands of the second command chain S_{CC}(2) have a second dependence relationship. In another example, the command chains S_{CC} may comprise command chains S_{CC}(1), S_{CC}(2), S_{CC}(3), . . . , etc., where the commands of one of these command chains are independent of the commands of another of these command chains.

Please note that the notations S_{T}(1), S_{T}(2), . . . , and S_{T}(N) are utilized for representing different sets of command chains, where a set of the sets S_{T}(1), S_{T}(2), . . . , and S_{T}(N) may comprise one or more command chains, and a command chain may comprise at least one command (e.g. one or more commands). In this embodiment, the controller 110 arranges the command chains S_{CC} into a plurality of sets respectively corresponding to the hardware modules 120-1, 120-2, . . . , and 120-N, such as the aforementioned sets S_{T}(1), S_{T}(2), . . . , and S_{T}(N), in order to execute the sets of command chains by utilizing the hardware modules 120-1, 120-2, . . . , and 120-N, respectively. Thus, the controller 110 arranges the command chains S_{CC} into the sets S_{T}(1), S_{T}(2), . . . , and S_{T}(N) to optimize the performance of the video processing circuit 100.

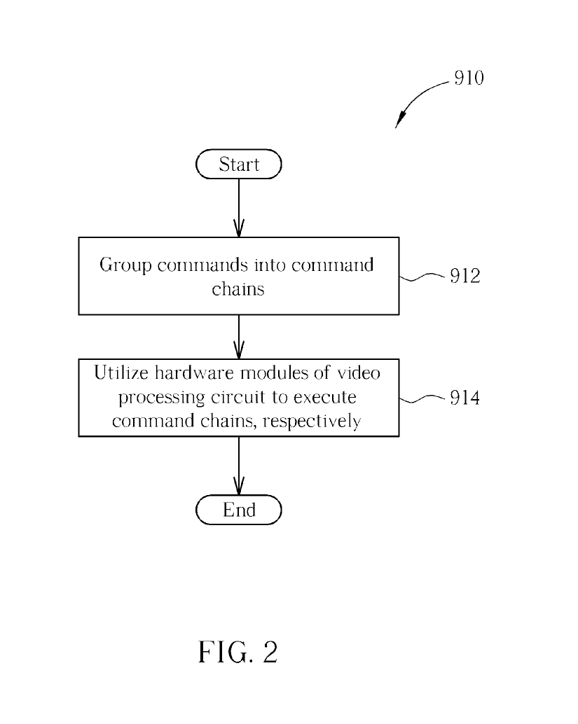

Based upon the architecture of the first embodiment, the video processing circuit 100 can properly control the video processing operations of the hardware modules 120-1, 120-2, . . . , and 120-N within the video processing circuit 100. Therefore, any system equipped with the video processing circuit 100 can operate efficiently. Some implementation details are further described according to FIG. 2.

FIG. 2 is a flowchart of a method 910 for performing video processing based upon a plurality of commands such as the commands S_{C} mentioned above according to one embodiment of the present invention. The method 910 shown in FIG. 2 can be applied to the video processing circuit 100 shown in FIG. 1. The method is described as follows.

In Step 912, the controller 110 groups the commands S_{C} into command chains, such as the aforementioned command chains S_{CC}, where the command chains S_{CC} have their respective dependence relationships. In particular, at a time when the commands S_{C} are grouped into the command chains S_{CC}, each command of one of the command chains S_{CC} is independent of any command of another of the command chains S_{CC}.

In Step 914, the controller 110 utilizes the hardware modules 120-1, 120-2, . . . , and 120-N to execute the command chains S_{CC}, respectively. In particular, the controller 110 arranges the command chains S_{CC} into a plurality of sets such as the aforementioned sets S_{T}(1), S_{T}(2), . . . , and S_{T}(N), in order to execute the sets of command chains by utilizing the hardware modules 120-1, 120-2, . . . , and 120-N, respectively.

In this embodiment, the controller 110 arranges the command chains S_{CC} into the sets S_{T}(1), S_{T}(2), . . . , and S_{T}(N) to optimize the performance of the video processing circuit 100. For example, the controller 110 may arrange the command chains S_{CC} into the sets S_{T}(1), S_{T}(2), . . . , and S_{T}(N) according to respective estimated times of executing the sets of command chains. This is for illustrative purposes only, and is not meant to be a limitation of the present invention. According to a variation of this embodiment, the processing capabilities of at least two of the hardware modules 120-1, 120-2, . . . , and 120-N are not equivalent to each other, and the controller 110 may arrange the command chains S_{CC} into the sets S_{T}(1), S_{T}(2), . . . , and S_{T}(N) according to respective processing capabilities of the hardware modules 120-1, 120-2, . . . , and 120-N.

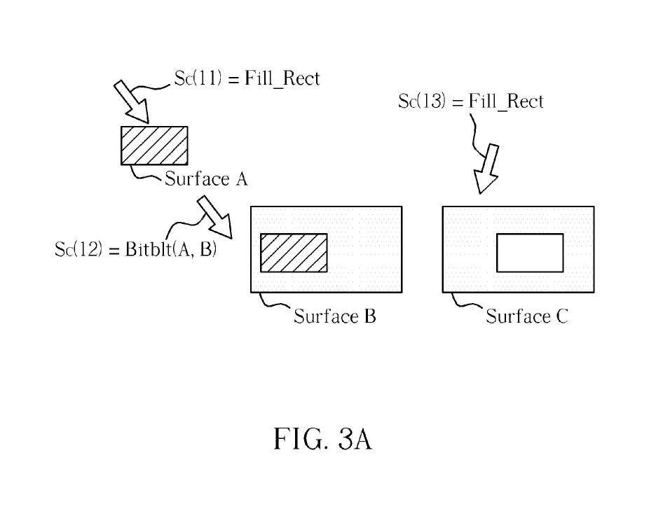

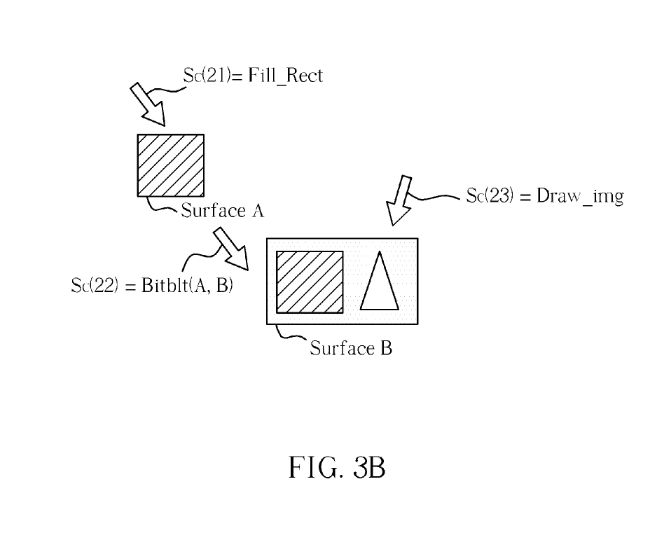

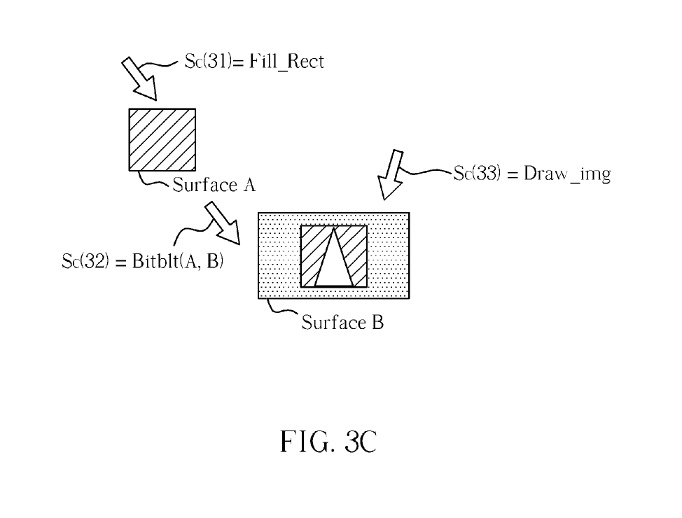

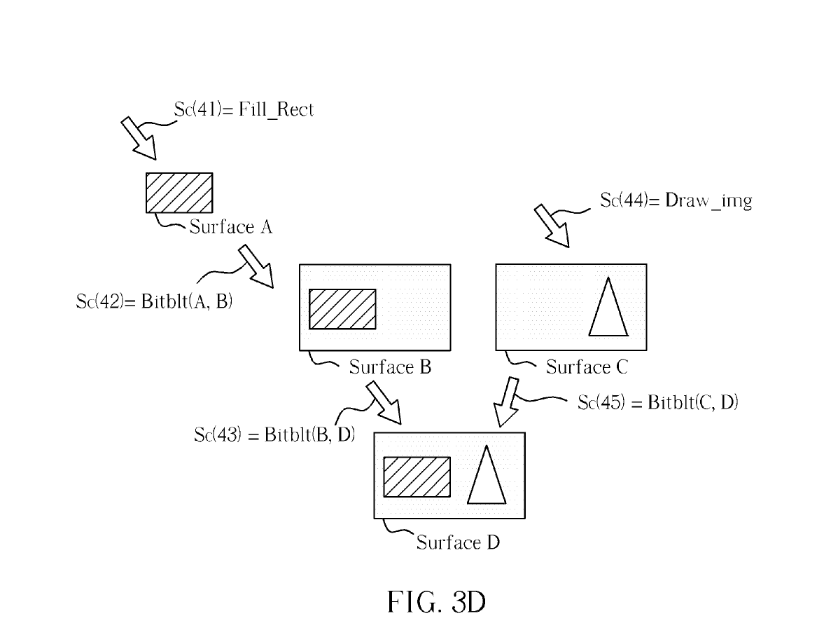

FIGS. 3A-3D illustrate some video processing operations involved with the method 910 shown in FIG. 2 according to different embodiments of the present invention. In these embodiments, some video processing commands such as “Fill_Rect”, “Bitblt”, and “Draw_img” shown in FIGS. 3A-3D are taken as examples of the commands S_{C}. Here, the video processing command Fill_Rect may represent a video processing operation of filling a rectangular with a color, the video processing command Bitblt may represent a video processing operation of pasting at least a portion of a surface to another surface, and the video processing command Draw_img may represent a video processing operation of drawing an image.

Referring to FIG. 3A, the commands S_{C} of this embodiment comprise the commands S_{C}(11), S_{C}(12), and S_{C}(13), which are the video processing commands Fill_Rect, Bitblt(A, B), and Fill_Rect, respectively. In a situation where the commands S_{C}(11), S_{C}(12), and S_{C}(13) are in the command queue 110K and are in the order as indicated by the indexes of the commands S_{C} (e.g. the indexes 11, 12, and 13), the controller 110 analyzes the commands S_{C}(11), S_{C}(12), and S_{C}(13), in order to execute Step 912. The command S_{C}(11) represents the video processing operation of filling a rectangular with a specific color on the surface A, and the command S_{C}(12) represents the video processing operation of pasting at least a portion of the surface A to the surface B. In addition, the command S_{C}(13) represents the video processing operation of filling a rectangular with a specific color on the surface C. As the dependence relationship between the commands S_{C}(11) and S_{C}(12) exists, and as the command S_{C}(13) is independent of the commands S_{C}(11) and S_{C}(12), the controller 110 groups the commands S_{C}(11) and S_{C}(12) into the same command chain S_{CC}(11), and further groups the command S_{C}(13) into a different command chain S_{CC}(12). As a result, the two command chains S_{CC}(11) and S_{CC}(12) can be executed in different hardware modules such as two of the hardware modules 120-1, 120-2, . . . , and 120-N. In particular, based upon the architecture shown in FIG. 1, the execution time of the command S_{C}(13) can be earlier than any of those of the commands S_{C}(11) and S_{C}(12).

Referring to FIG. 3B, the commands S_{C} of this embodiment comprise the commands S_{C}(21), S_{C}(22), and S_{C}(23), which are the video processing commands Fill_Rect, Bitblt(A, B), and Draw_img, respectively. In a situation where the commands S_{C}(21), S_{C}(22), and S_{C}(23) are in the command queue 110K and are in the order as indicated by the indexes of the commands S_{C} (e.g. the indexes 21, 22, and 23), the controller 110 analyzes the commands S_{C}(21), S_{C}(22), and S_{C}(23), in order to execute Step 912. The command S_{C}(21) represents the video processing operation of filling a rectangular with a specific color on the surface A, and the command S_{C}(22) represents the video processing operation of pasting at least a portion of the surface A to the surface B. In addition, the command S_{C}(23) represents the video processing operation of drawing an image such as a triangle on the surface B. It is detected that, on the surface B, the triangle generated by the command S_{C}(23) and the rectangular generated by the command S_{C}(22) should not overlap. As the dependence relationship between the commands S_{C}(21) and S_{C}(22) exists, and as the command S_{C}(23) is independent of the commands S_{C}(21) and S_{C}(22), the controller 110 groups the commands S_{C}(21) and S_{C}(22) into the same command chain S_{CC}(21), and further groups the command S_{C}(23) into a different command chain S_{CC}(22). As a result, the two command chains S_{CC}(21) and S_{CC}(22) can be executed in different hardware modules such as two of the hardware modules 120-1, 120-2, . . . , and 120-N. In particular, based upon the architecture shown in FIG. 1, the execution time of the command S_{C}(23) can be earlier than any of those of the commands S_{C}(21) and S_{C}(22).

Referring to FIG. 3C, the commands S_{C} of this embodiment comprise the commands S_{C}(31), S_{C}(32), and S_{C}(33), which are the video processing commands Fill_Rect, Bitblt(A, B), and Draw_img, respectively. In a situation where the commands S_{C}(31), S_{C}(32), and S_{C}(33) are in the command queue 110K and are in the order as indicated by the indexes of the commands S_{C} (e.g. the indexes 31, 32, and 33), the controller 110 analyzes the commands S_{C}(31), S_{C}(32), and S_{C}(33), in order to execute Step 912. The command S_{C}(31) represents the video processing operation of filling a rectangular with a specific color on the surface A, and the command S_{C}(32) represents the video processing operation of pasting at least a portion of the surface A to the surface B. In addition, the command S_{C}(33) represents the video processing operation of drawing an image such as a triangle on the surface B. It is detected that, on the surface B, the triangle generated by the command S_{C}(33) should be drawn on the rectangular generated by the command S_{C}(32). As the dependence relationship between the commands S_{C}(31), S_{C}(32), and S_{C}(33) exists, the controller 110 groups the commands S_{C}(31), S_{C}(32), and S_{C}(33) into the same command chain S_{CC}(30). As a result, the commands S_{C}(31), S_{C}(32), and S_{C}(33) in the command chain S_{CC}(30) should be executed in the same hardware module such as one of the hardware modules 120-1, 120-2, . . . , and 120-N, where the command S_{C}(33) should be executed after the commands S_{C}(31) and S_{C}(32) are executed.

Referring to FIG. 3D, the commands S_{C} of this embodiment comprise the commands S_{C}(41), S_{C}(42), S_{C}(43), S_{C}(44), and S_{C}(45), which are the video processing commands Fill_Rect, Bitblt(A, B), Bitblt(B, D), Draw_img, and Bitblt(C, D), respectively. In a situation where the commands S_{C}(41), S_{C}(42), S_{C}(43), S_{C}(44), and S_{C}(45) are in the command queue 110K and are in the order as indicated by the indexes of the commands S_{C} (e.g. the indexes 41, 42, 43, 44, and 45), the controller 110 analyzes the commands S_{C}(41), S_{C}(42), S_{C}(43), S_{C}(44), and S_{C}(45), in order to execute Step 912. The command S_{C}(41) represents the video processing operation of filling a rectangular with a specific color on the surface A, the command S_{C}(42) represents the video processing operation of pasting at least a portion of the surface A to the surface B, and the command S_{C}(43) represents the video processing operation of pasting at least a portion of the surface B to the surface D. In addition, the command S_{C}(44) represents the video processing operation of drawing an image such as a triangle on the surface C, and the command S_{C}(45) represents the video processing operation of pasting at least a portion of the surface C to the surface D. For example, it is detected that, on the surface D, the triangle generated by the command S_{C}(45) and the rectangular generated by the command S_{C}(43) should not overlap. As the dependence relationship between the commands S_{C}(41), S_{C}(42), and S_{C}(43) exists and the dependence relationship between the commands S_{C}(44) and S_{C}(45) exists, and as the commands S_{C}(44) and S_{C}(45) are independent of the commands S_{C}(41), S_{C}(42), and S_{C}(43), the controller 110 groups the commands S_{C}(41), S_{C}(42), and S_{C}(43) into the same command chain S_{CC}(41), and further groups the commands S_{C}(44) and S_{C}(45) into a different command chain S_{CC}(42). As a result, the two command chains S_{CC}(41) and S_{CC}(42) can be executed in different hardware modules such as two of the hardware modules 120-1, 120-2, . . . , and 120-N. In particular, based upon the architecture shown in FIG. 1, the execution time of any of the commands S_{C}(44) and S_{C}(45) can be earlier than any of those of the commands S_{C}(41), S_{C}(42), and S_{C}(43).

In the embodiment shown in FIG. 3D, the controller 110 can analyze whether any dependence relationship between the commands S_{C}(43) and S_{C}(45) exists. This is for illustrative purposes only, and is not meant to be a limitation of the present invention. According to a variation of this embodiment, as it is complicated to analyze whether any dependence relationship between the commands S_{C}(43) and S_{C}(45) exists, the controller 110 may simply groups all of the commands S_{C}(41), S_{C}(42), S_{C}(43), S_{C}(44), and S_{C}(45) into the same command chain S_{CC}(40), in order to reduce the associated processing load of analyzing the commands S_{C}. As a result, the commands S_{C}(41), S_{C}(42), S_{C}(43), S_{C}(44), and S_{C}(45) in the command chain S_{CC}(40) should be executed in the same hardware module such as one of the hardware modules 120-1, 120-2, . . . , and 120-N, where the command S_{C}(44) should be executed after the commands S_{C}(41), S_{C}(42), and S_{C}(43) are executed, and the command S_{C}(45) should be executed after the command S_{C}(44) is executed.

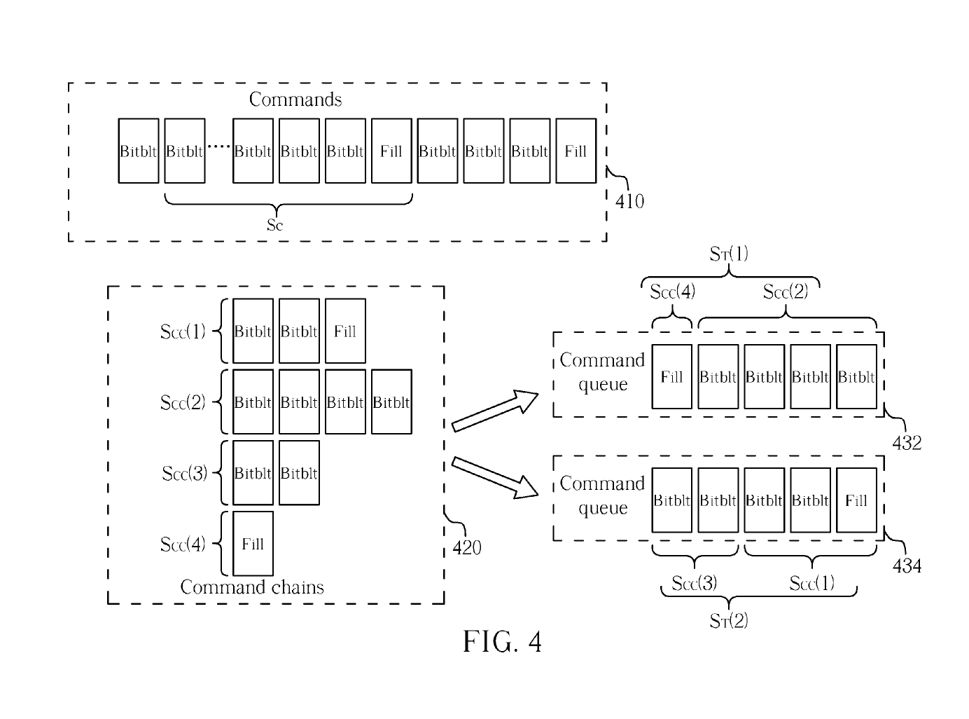

FIG. 4 illustrates some implementation details of the method shown in FIG. 2 according to an embodiment of the present invention. For example, the aforementioned commands S_{C} can be regarded as a portion of the commands 410 shown in FIG. 4, and are now in the command queue 110K of the controller 110, where the notation “Fill” shown in FIG. 4 is utilized for representing the video processing command Fill_Rect mentioned above for brevity. According to this embodiment, the controller 110 may group the commands S_{C} into command chains 420 such as the command chains S_{CC}(1), S_{CC}(2), S_{CC}(3), and S_{CC}(4), respectively. Please note that each hardware module 120-n of the hardware modules 120-1, 120-2, . . . , and 120-N can be utilized for executing at least one command chain, where n=1, 2, . . . , or N. In practice, the controller 110 can send the aforementioned at least one command chain into a command queue of the hardware module 120-n, in order to utilize the hardware module 120-n to execute the aforementioned at least one command chain.

In this embodiment, suppose that N=2, and the aforementioned hardware module 120-n may represent the hardware module 120-1 or the hardware module 120-2. Thus, the controller 110 arranges the command chains S_{CC}(2) and S_{CC}(4) into the set S_{T}(1) corresponding to the hardware module 120-1 and further arranges the command chains S_{CC}(1) and S_{CC}(3) into the set S_{T}(2) corresponding to the hardware module 120-2, in order to optimize the performance of the video processing circuit 100. In addition, the controller 110 sends the command chains S_{CC}(2) and S_{CC}(4) into a command queue 432 of the hardware module 120-1, in order to utilize the hardware module 120-1 to execute the command chains S_{CC}(2) and S_{CC}(4). Additionally, the controller 110 sends the command chains S_{CC}(1) and S_{CC}(3) into a command queue 434 of the hardware module 120-2, in order to utilize the hardware module 120-2 to execute the command chains S_{CC}(1) and S_{CC}(3). As a result, the processing load of the hardware module 120-1 may be equivalent to or similar to that of the hardware module 120-2, and when the operations of all the commands in one of the command queues 432 and 434 are completed, the operations of all the commands in the other of the command queues 432 and 434 can be completed almost at the same time. Similar descriptions for this embodiment are not repeated in detail.

It is an advantage of the present invention that, based upon the architecture of the embodiments/variations disclosed above, the goal of maintaining the balance between the hardware modules (e.g. GPUs) within the video processing circuit can be achieved. In a situation where there are many commands, the present invention method and the associated video processing circuit can properly handle the situation with ease. In addition, no time will be wasted since hardware resources such as the hardware modules mentioned above can be fully utilized most of the time.

Those skilled in the art will readily observe that numerous modifications and alterations of the device and method may be made while retaining the teachings of the invention. Accordingly, the above disclosure should be construed as limited only by the metes and bounds of the appended claims.

1. A method for performing video processing based upon a plurality of commands, the method being applied to a video processing circuit, the method comprising:
grouping the commands into command chains, wherein the command chains have respective dependence relationships; and
utilizing a plurality of hardware modules of the video processing circuit to execute the command chains, respectively.

2. The method of claim 1, wherein at a time when the commands are grouped into the command chains, each command of one of the command chains is independent of any command of another of the command chains.

3. The method of claim 1, wherein the command chains comprise a first command chain and a second command chain; and commands of the first command chain have a first dependence relationship, and commands of the second command chain have a second dependence relationship.

4. The method of claim 1, wherein the step of utilizing the plurality of hardware modules of the video processing circuit to execute the command chains further comprises:
arranging the command chains into a plurality of sets respectively corresponding to the hardware modules, in order to execute the sets of command chains by utilizing the hardware modules, respectively.

5. The method of claim 4, wherein the step of utilizing the plurality of hardware modules of the video processing circuit to execute the command chains further comprises:
arranging the command chains into the sets to optimize performance of the video processing circuit.

6. The method of claim 4, wherein the step of utilizing the plurality of hardware modules of the video processing circuit to execute the command chains further comprises:
arranging the command chains into the sets according to respective estimated times of executing the sets of command chains.

7. The method of claim 4, wherein the step of utilizing the plurality of hardware modules of the video processing circuit to execute the command chains further comprises:
arranging the command chains into the sets according to respective processing capabilities of the hardware modules.

8. The method of claim 1, wherein each hardware module is utilized for executing at least one command chain.

9. The method of claim 8, further comprising:
sending the at least one command chain into a command queue of the hardware module, in order to utilize the hardware module to execute the at least one command chain.

10. The method of claim 1, wherein processing capabilities of at least two of the hardware modules are not equivalent to each other.

11. A video processing circuit, comprising:
a plurality of hardware modules arranged to perform video processing based upon a plurality of commands; and
a controller arranged to group the commands into command chains, wherein the command chains have respective dependence relationships;
wherein the controller utilizes the hardware modules to execute the command chains, respectively.

12. The video processing circuit of claim 11, wherein at a time when the commands are grouped into the command chains, each command of one of the command chains is independent of any command of another of the command chains.

13. The video processing circuit of claim 11, wherein the command chains comprise a first command chain and a second command chain; and commands of the first command chain have a first dependence relationship, and commands of the second command chain have a second dependence relationship.

14. The video processing circuit of claim 11, wherein the controller arranges the command chains into a plurality of sets respectively corresponding to the hardware modules, in order to execute the sets of command chains by utilizing the hardware modules, respectively.

15. The video processing circuit of claim 14, wherein the controller arranges the command chains into the sets to optimize performance of the video processing circuit.

16. The video processing circuit of claim 14, wherein the controller arranges the command chains into the sets according to respective estimated times of executing the sets of command chains.

17. The video processing circuit of claim 14, wherein the controller arranges the command chains into the sets according to respective processing capabilities of the hardware modules.

18. The video processing circuit of claim 11, wherein each hardware module is utilized for executing at least one command chain.

19. The video processing circuit of claim 18, wherein the controller sends the at least one command chain into a command queue of the hardware module, in order to utilize the hardware module to execute the at least one command chain.

20. The video processing circuit of claim 11, wherein processing capabilities of at least two of the hardware modules are not equivalent to each other.
